(19) United States
(12) Patent Application Publication
(10) Pub. No.: US 2025/0267694 A1
(43) Pub. Date: Aug. 21, 2025

(54) CONFIGURATION INFORMATION

(71) Applicant: FRAUNHOFER-GESELLSCHAFT ZUR FÖRDERUNG DER ANGEWANDTEN FORSCHUNG E.V., München (DE)

(72) Inventors: Paul Simon Holt LEATHER, Berlin (DE); Thomas HAUSTEIN, Berlin (DE)

(21) Appl. No.: 19/203,886

(22) Filed: May 9, 2025

Related U.S. Application Data
(63) Continuation of application No. PCT/EP2023/081339, filed on Nov. 9, 2023.

(30) Foreign Application Priority Data
Nov. 11, 2022 (EP) 22206969.2

(51) Int. Cl. H04W 72/50

(52) U.S. Cl. CPC H04W 72/535

(57) ABSTRACT

Embodiments provide a network entity configured for a communication in a wireless communication system according to a configuration using a resource of the wireless communication system. The network entity is configured for using a wireless interface of the network entity for the communication. The network entity comprises a control unit configured for processing configuration information indicating a change of an availability of the resource. The control unit is configured for adapting the configuration based on the configuration information to react on the change of the availability.

### CROSS-REFERENCE TO RELATED APPLICATIONS

This application is a continuation of copending International Application No. PCT/EP2023/081339, filed Nov. 9, 2023, which is incorporated herein by reference in its entirety, and additionally claims priority from European Application No. 22206969.2, filed Nov. 11, 2022, which is also incorporated herein by reference in its entirety.

Embodiments of the present application relate to the field of wireless communication, and more specifically, to wireless communication in a wireless communication system, the communication relying on the use of resources. Some embodiments relate to configuration information (CI) that allows to mitigate the effects of communication resource limitations.

### BACKGROUND OF THE INVENTION

FIG. 1 is a schematic representation of an example of a terrestrial wireless network 100 including, as is shown in FIG. 1 (a), a core network 102 and one or more radio access networks RAN1, RAN2, . . . . RANN. FIG. 1 (b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device.

The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1 (b) shows an exemplary view of five cells, however, the RANn may include more or less such cells, and RANn may also include only one base station. FIG. 1 (b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1 (b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1 (b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1 (b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

Based thereon, consider a wireless communication system (WCS) comprised of entities equipped with the means to communicate via a radio access network (RAN). In certain situations, even a very carefully designed and deployed WCS might experience scenarios in which not all of the entities (e.g. user equipment (UE) devices) can establish communication links with other entities or cannot establish or maintain links which satisfy requested quality of service, QoS parameters. This could result from one or more of the following examples:

inadequate coverage in remote, isolated, blocked, shaded or otherwise strongly attenuated environments; a reduced availability or a complete unavailability of communication resources; access link limitations; backhaul link limitations; control channel limitations; or an imbalance in the uplink and downlink. Generally speaking, the first set refers to coverage whilst all other sets refer to service—hence the terms “in coverage” (IC), “out of coverage” (OOC), “in service” (IS) and “out of service” (OOS).

In list form, resource limitations refer to the reduced availability or the complete unavailability of:
Access link (e.g. Uu, NTN, sidelink, SSBs, Wi-Fi)
Backhaul link
Relay link
Control channel (in access or backhaul link)
Link imbalance (downlink versus uplink)
A RIS
one or more symbols,
one or more time slots or subframes or frames,
one or more frequencies or carriers or subchannels or group of subchannels,
one or more subcarriers, e.g., for transmission of IoT messages like NB-IoT, LoRA etc.
one or more interfaces,
one or more channels e.g., a control channel, a user data channel or any other channel for a dedicated purpose
one or more resource block sets, RB sets,
one or more frequency bands, like unlicensed subbands,
one or more bandwidth parts,
one or more resource pools,
one or more LBT sub-bands,
one or more spatial resources, e.g., using spatial multiplexing, directional beams etc.
one or more than one resource,
a sub-channel,
a sub-band,

Furthermore, the device, e.g., a UE, may be communicating with another network entity, wherein the other network entity or destination entity comprises one or more of the following:
a further base station, BS,
a roadside unit, RSU,
an orbital side unit (equivalent of a roadside unit, where satellites or airplanes pass by and can exchange information with the RSU)
a mobile BS mounted on a land or water vehicle e.g., a car, bus, train, ship/vessel, submarine or on a container loaded thereon or on any piece of equipment mounted on or attached to the vehicle
a mobile BS mounted on a non-terrestrial/air-borne vehicle or device e.g., an aircraft, UAV, balloon, rocket, satellite or any other object/device moving/floating in 3D-space without being in touch with the surface of a planet or a liquid on the planet (e.g. water of a lake or the sea)
a further UE,
a Customer Premises Equipment, CPE
an IoT device,
a broadcast tower like one used for digital audio (radio) or Television (video) broadcast
a relay device,
a further relay device,
a core network,
function located somewhere in the communication network, e.g., a UPF, LMF, AMF, SMF etc.
an application server connected to the core network,
an aggregation node for e.g., storage, processing (fusion, decision making, computing outputs) or forwarding of sensor data, messages, retransmissions, AIM, measurements reports, configurations etc.,
a data base.

In such scenarios, a UE that relies on another network entity (e.g. a basestation (BS)) to provide it with configuration information—information that includes parameter settings such as power, frequency, modulation, channel number, carrier assignment, time-frequency assignment, pattern characteristics and the such like—is unlikely to obtain such information from the other network entity due to one or more of the conditions listed above.

A problem arising in known networks relates to degradation of, interruption in, drop of or unavailability of a communication link due to shortage of communication resources below a level suitable for a needed, selected, targeted mode of operation of a communication link with its associated parameters and metrics.

### SUMMARY

According to an embodiment, a network entity configured for a communication in a wireless communication system according to a configuration using a resource of the wireless communication system and for using a wireless interface of the network entity for the communication may have: a control unit configured for processing configuration information indicating a change of an availability of the resource; wherein the control unit is configured for adapting the configuration based on the configuration information to react on the change of the availability.

According to another embodiment, a network entity configured for operating in a wireless communication system may have: a control unit configured for processing configuration information indicating a change in an availability of the resource; wherein the control unit is configured for reacting on the change of the availability by performing by at least one of a measurement, a logging, a reporting, an acknowledging, and combinations thereof related to the availability; and for providing a result thereof to the wireless communications system.

According to another embodiment, a network entity configured for a communication in a wireless communication system may have: a control unit configured for generating configuration information indicating a change of an availability of a resource of the wireless communication system for a different network entity of the wireless communication system; wherein the network entity is configured for providing the configuration information to the wireless communication system and/or the different network entity.

According to another embodiment, a wireless communication system providing wireless communication between different entities of the wireless communication system according to a configuration, the communication using a resource of the wireless communication system, may have: a first entity being configured for providing, to at least one member of the wireless communication system, configuration information indicating a change of an availability of a resource of the wireless communication system; a second entity that is configured for adapting the configuration based on the configuration information to mitigate an effect of the change of the availability on at least one entity of the wireless communication system.

According to another embodiment, a method for operating a network entity configured for a communication in a wireless communication system according to a configuration using a resource of the wireless communication system and for using a wireless interface of the network entity for the communication, may have the steps of: processing, with a control unit of the network entity, configuration information indicating a change of an availability of the resource; adapting the configuration based on the configuration information to react on the change of the availability.

According to another embodiment, a method for operating a network entity configured for operating in a wireless communication system may have the steps of: processing, using a control unit of the network entity, configuration information indicating a change in an availability of the resource; reacting on the change of the availability by performing by at least one of a measurement, a logging, a reporting, an acknowledging, and combinations thereof related to the availability; and providing a result thereof to the wireless communications system.

According to another embodiment, a method for operating a network entity configured for a communication in a wireless communication system may have the steps of: generating configuration information indicating a change of an availability of a resource of the wireless communication system for a different network entity of the wireless communication system using a control unit of the network entity; providing the configuration information to the wireless communication system and/or the different network entity.

Another embodiment relates to a non-transitory digital storage medium having a computer program stored thereon to perform any of the inventive methods when said computer program is run by a computer.

A finding of the present invention is that reliability of communication in a wireless communication system may be improved when compared to known systems and maybe significantly improved by making unexpected changes in the wireless communication system expected for the network entity, e.g., a UE such that it can react on a changed availability of a resource with respect to a change in the past, the present or in future. According to the present invention, the network entity is provided with configuration information that indicates the change of the availability that would elsewise be, within the implemented (known) communication standard be unknown to the network entity.

It is noted that the information in the above section is only for enhancing the understanding of the background of the invention and therefore it may contain information that does not form conventional technology and is already known to a person of ordinary skill in the art.

### BRIEF DESCRIPTION OF THE DRAWINGS

Embodiments of the present invention will be detailed subsequently referring to the appended drawings, in which:

FIG. 1 shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 shows a schematic block diagram of a network entity using configuration information according to an embodiment; and

FIG. 8 shows a schematic block diagram of a network entity providing configuration information according to an embodiment; and

FIG. 9 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

A wireless communication system as described above serves only as an example of a system that may benefit from the advantages obtained by the present invention. Embodiments are not limited to terrestrial networks but also cover non-terrestrial networks or combinations thereof. Alternatively or in addition, terminals, base stations and/or other network entities may but are not required to be mobile and may, thus, be individually, in groups or globally within the communication system be stationary.

In list form, known configuration information can contain the present and future availability or unavailability relating to:
Spatial resources
Temporal resources
Spectral resources
Coverage
Beams
Service provided by gNB, sidelink, satellite, RIS, repeater

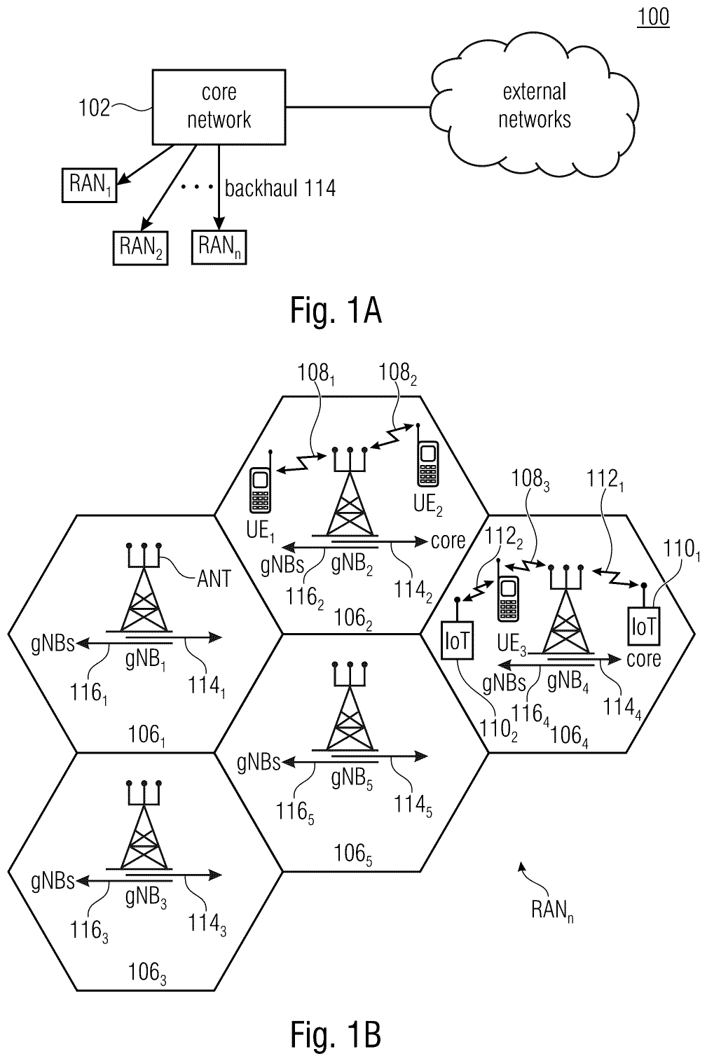

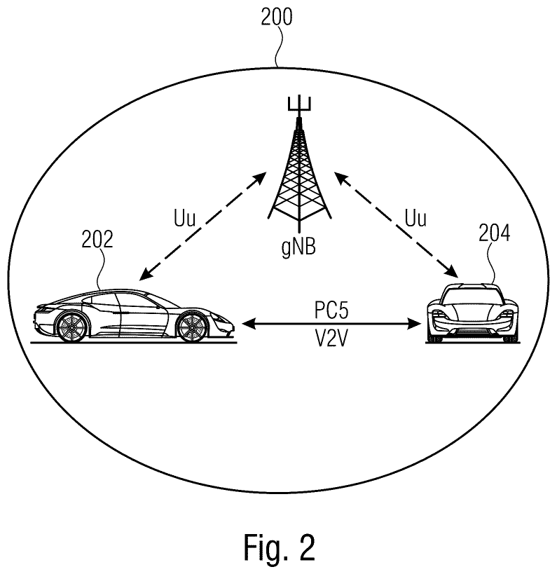

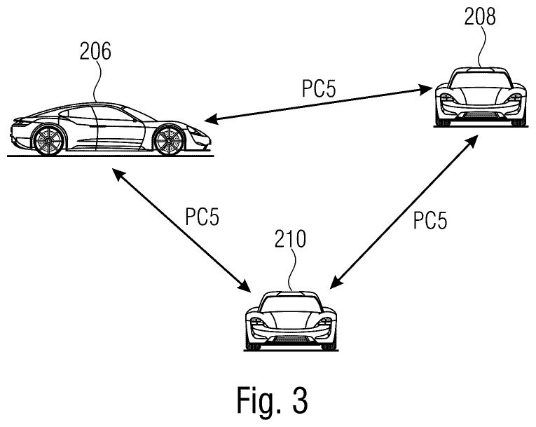

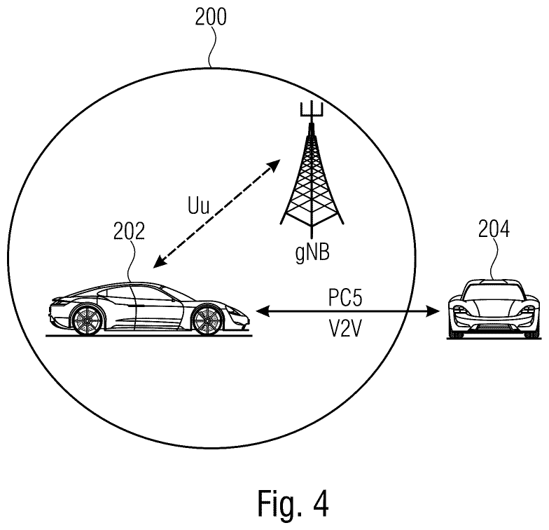

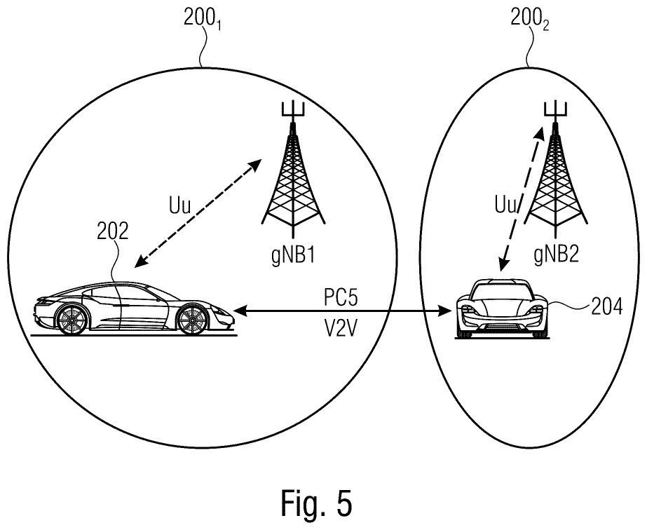

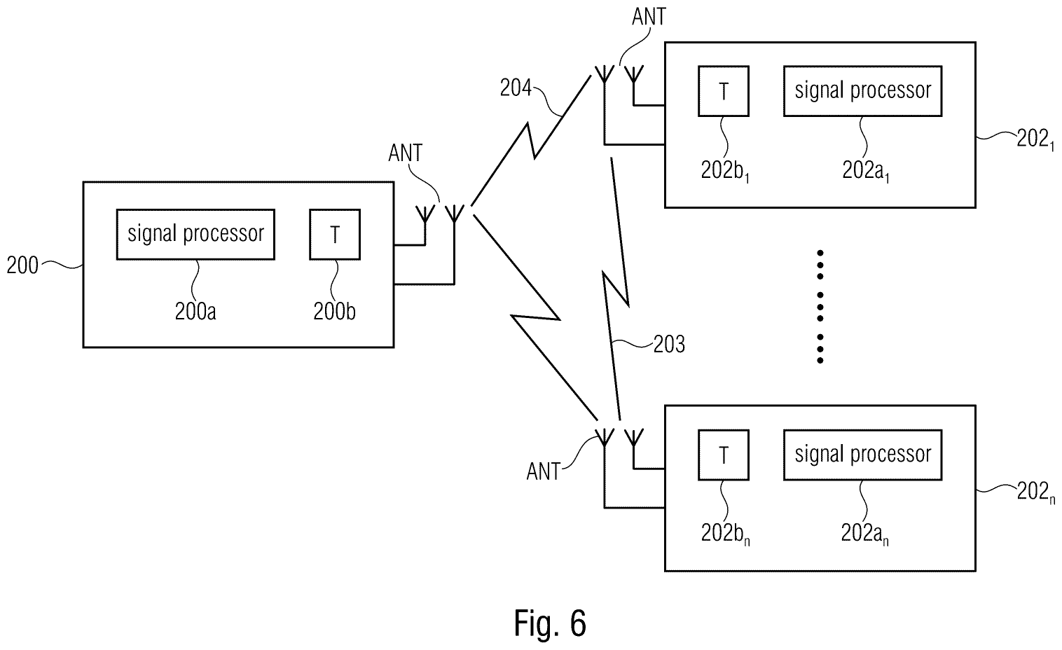

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

According to an embodiment, a network entity is configured for a communication in a wireless communication system according to a configuration using a resource of the wireless communication system and for using a wireless interface of the network entity for the communication, the network entity comprising a control unit configured for processing configuration information indicating a change of an availability of the resource. The configuration information may be available for or transmitted to the network entity, e.g., wirelessly received, (pre-) configured, stored thereon, or the like. The control unit is configured for adapting the configuration based on the configuration information to react on the change of the availability.

According to an embodiment the network entity is a user equipment, UE, that is configured for adapting the configuration to change its behavior in the wireless communication system based on the change of the availability of the resource.

According to an embodiment the change relates to an anomalous availability of the resource and/or a significant change of the availability.

According to an embodiment the configuration information leads the anomalous change to be an expected situation for the network entity.

According to an embodiment the anomalous availability relates to at least one of:
a time, e.g., being a start, end, period/interval/duration or change of state or change of trend, related to at least one of:
   an availability and/or non-availability of the resource;
   an occurrence of a blockage event blocking at least a part of the communication;
   an occurrence of an outage event and/or an outage period of the communication;
   an occurrence of an interference event and/or a jamming event influencing the communication;
   an occurrence of an energy related state and/or a power related state of the communication; e.g., low battery state, recharging time, estimated remaining energy, transmit power constraints due to EIRP restrictions, multi-band operation, interference constraints
a resource is subject to
   a decrease below a threshold of at least one parameter relevant for the communication,
   an increase above a threshold of at least one parameter relevant for the communication,
   a maintain within or outside a corridor of values of at least one parameter relevant for the communication,
   maintain within or outside a region or area of validity of at least one parameter relevant for the communication with respect to a metric, e.g., coverage, capacity, data rate, reliability, latency]
   a particular distribution, e.g., of parameters and/or states across a dimensions of at least one parameter relevant for the communication using the resource, e.g., in time, frequency, space, directions, location, etc.
a constraint related to the resource in view of at least one of:
   a provided data volume;
   an allocated spectrum and/or resource block (RB);
   a modulation and coding scheme (MCS) used for the communication;
   a block size used for the communication
   a size of a message, a volume such as data volume or a size of a folder/file and/or a number of messages, e.g., per unit time and/or unit of opportunity
   a change of any above, e.g., states/values or trends (increase→decrease, decrease→increase)
   a particular or repeated pattern, a distribution, a statistic, a state, a value and/or a trend of occurrence

According to an embodiment the configuration information relates to an availability of the resource; or wherein the configuration information relates to an at least partial unavailability of the resource.

According to an embodiment configuration information indicates the change of the availability for a past, present and/or future instance of time.

According to an embodiment the control unit is configured for processing the configuration information to obtain a processing result that indicates an at least partial and/or at least temporal unavailability of the resource for the communication; and wherein the control unit is configured for controlling the network entity to avoid the communication using the resource based on the processing result.

According to an embodiment the control unit is configured for processing the configuration information to obtain a processing result that indicates a restored availability of the resource for the communication and/or that indicates an established availability of the resource; and wherein the control unit is configured for controlling the network entity to postpone the communication using the resource based on the processing result until the availability of the resource for the communication is restored or established.

According to an embodiment the configuration relates to at least one of:
a transmission, a reception, and combinations thereof provided by the network entity as the communication;
a measurement, a logging, a reporting an acknowledging, and combinations thereof to be provided by the network entity;
a transmission and/or a reception of at least one preconfigured signal such as a test signal, of at least one preconfigured reference signal, and/or of at least one preconfigured message such as a test message;
a performing of a procedure of transmission of at least one signal and/or a procedure of reception of at least one signal and processing thereof, e.g., beam sweeping, frequency sweep.

According to an embodiment the resource comprises at least one of:
an access link resource, a sidelink resource, a relay link resource and/or a backhaul link resource;
a temporal, spectral, sequential (spreading sequence) and/or spatial communication resource;
a transport channel, a positioning channel, a control channel and/or a data channel;
a transmission/reception beam represented by a beam-ID, SSB, CSI-RS, a beam sweep and/or a coordinated beam constellation;
a propagation channel component such as a line-of-sight, LOS, non-line-of-sight, NLOS, obstructed line-of-sight, OLOS, a dominant or specific multi-path component, (MPC;
a service or connectivity provided by another network entity such as a gNB, core network, access network, repeater, RIS, satellite;
a quality of service, Qos, related to communication metrics such as coverage, capacity, latency and/or jitter

According to an embodiment the configuration information comprises at least one of:
information indicating at least one trigger indicating to start or stop a particular action/behaviour of the device;
information indicating at least one event which is relevant to the communication scenario;
information indicating at least one condition which describes e.g., the communication scenario, status values/messages of the UE or other network devices;
information indicating a combination or sequence thereof indicating at least one of:
   a state, e.g., of a state machine
   a status, e.g., of a report, action, confirmation or acknowledgment
   a period, of a parameter being below/above a threshold or within a range OR a certain state/status is given/valid/invalid
   an event,
   a request of an action, observation and/or measurement
   a report relating to an action, observation and/or measurement
   an action, e.g., of stopping a counter, continuing until something else happens
   a procedure, to:
      start/pause/continue/end;
      activate/deactivate; and/or
      confirm/acknowledge, e.g., of actions, reports, status

According to an embodiment the configuration information comprises information indicating an event or trigger; wherein based on the processing, the control unit is configured for controlling the network entity responsive to the event or trigger to at least one of:
starting, stopping, resetting and/or halting of at least one counter and/or count-down timer;
capturing, freezing, storing, forwarding a current and/or future, e.g., anticipated state and/or configuration;
an automatic (re)-configuration of the network device and/or its behaviour after a trigger, after an event occurred and/or after a condition is met;
starting, halting, delaying, restarting and/or preparing to start a procedure or mode of operation of the network entity,
changing from one procedure, routine or mode of operation into another one;
determining or selecting a mode of operation and/or a transmission/reception strategy;
discovering, observing, detecting, monitoring and/or tracing an events and/or a parameter related to any of the above configuration information and/or associated actions, triggers, configuration variants thereof; as an example a UE may be observing pattern of availability of one or more beams based on RS or beam-ID and determining or reporting future availability, based on this another device e.g., a gNB or RIS can be configured to go/remain in particular configuration states such that a certain coverage/capacity requirement of a particular UE is fulfilled)
preparing a transmission and/or reception of at least one of a report, a message, control data and user data; for preparing of a future, e.g., subsequent or next connection availability events.

Although having a related or even similar meaning, some differences may be formulated, at least in connection with some embodiments, relating to the term event, condition/state and trigger. For example, an event may be understood, in some context, a something that happens—e.g. a loss of service, a loss of coverage, a power failure

Compared hereto, a condition may relate to a particular state—e.g. the Signal-to-interference-plus-noise-ratio (SINR) which is below some amount, the Reference Signal Received Power (RSRP)/Reference Signal Received Quality (RSRQ)/RSSI (Received Signal Strength Indicator)/Round Trip Delay (RTD) which is below/above a predefined value and/or within a range of values or the like. A trigger may be understood, for example, as a result of a particular event occurring.

According to an embodiment the network entity is configured for obtaining the configuration information based on at least one of:
as a pre-set or pre-configured information, e.g. by default, factory settings, recently updated
based on a past or last used, present or future mode of operation or a change in the mode of operation, e.g. from Uu to sidelink, from sidelink to Uu, from Uu to NTN, from NTN to Uu, from SL to NTN or from NTN to SL. as information provided by the wireless communication system or network
as information provided by a database, e.g. connected to the RAN as an entity
as information provided via an alternative radio access network, RAN, e.g. Wi-Fi, Bluetooth or the like
as information provided by a remote UE and/or a group leader UE

According to an embodiment the network entity is configured for obtaining the configuration information as one of a plurality of configuration information.

According to an embodiment the network entity is configured for receiving at least one of the plurality of configuration information by receiving and processing a wireless signal.

According to an embodiment the network entity is configured for obtaining a first configuration information that causes the control unit to control the network entity into an operation mode supported by a wireless communication system controller such as a gNB, e.g., via a radio resource control, RRC, message;

wherein the network entity is configured for obtaining a second configuration information that causes the control unit to control the network entity into one of different behaviors within the operation mode.

According to an embodiment the network entity is configured for receiving at least a part of the first configuration information by receiving a radio resource control, RRC, message; wherein the network entity is configured for obtaining at least a part of the second configuration information by receiving a transmission control information, TCI.

According to an embodiment the network entity is a user equipment, UE.

According to an embodiment the configuration information is a first configuration information; wherein the control unit is configured for generating the first configuration information and/or for generating a second configuration information indicating a change of an availability of a resource of the wireless communication system for a different network entity of the wireless communication system; wherein the network entity is configured for providing the first configuration information and/or the second first configuration information to the wireless communication system and/or the different network entity.

According to an embodiment a network entity configured for operating in a wireless communication system comprises a control unit configured for processing configuration information indicating a change in an availability of the resource; wherein the control unit is configured for reacting on the change of the availability by performing by at least one of a measurement, a logging, a reporting, an acknowledging, and combinations thereof related to the availability; and for providing a result thereof to the wireless communications system.

According to an embodiment a network entity configured for a communication in a wireless communication system comprises: a control unit configured for generating configuration information indicating a change of an availability of a resource of the wireless communication system for a different network entity of the wireless communication system; wherein the network entity is configured for providing the configuration information to the wireless communication system and/or the different network entity.

According to an embodiment the network entity is a user equipment, UE configured for wirelessly providing the configuration information using a wireless interface of the network entity.

According to an embodiment the network entity is a base station, gNB, configured for wirelessly providing the configuration information using a wireless interface of the network entity.

According to an embodiment the configuration information is a first configuration information and wherein the resource is a first resource; wherein the network entity is configured for a communication in the wireless communication system according to a configuration using a same or different second resource of the wireless communication system and for using a wireless interface of the network entity for the communication; wherein the control unit is configured for processing second configuration information indicating a change of an availability of the second resource; wherein the control unit is configured for adapting the configuration based on the second configuration information to react on the change of the availability.

According to an embodiment a wireless communication system is provided, providing wireless communication between different entities of the wireless communication system according to a configuration, the communication using a resource of the wireless communication system, the wireless communication system comprising a first entity such as a UE, gNB, database or data storage being configured for providing, to at least one member of the wireless communication system, configuration information indicating a change of an availability of a resource of the wireless communication system; and a second entity that is configured for adapting the configuration based on the configuration information to mitigate an effect of the change of the availability on at least one entity of the wireless communication system.

According to an embodiment the first entity is a network entity according to an embodiment described herein, in particular a network entity to use configuration information; and/or the second entity is a network entity according to an embodiment, in particular a network entity to provide configuration information.

According to an embodiment a method for operating a network entity configured for a communication in a wireless communication system according to a configuration using a resource of the wireless communication system and for using a wireless interface of the network entity for the communication comprises processing, with a control unit of the network entity, configuration information indicating a change of an availability of the resource; adapting the configuration based on the configuration information to react on the change of the availability.

According to an embodiment a method for operating a network entity configured for operating in a wireless communication system comprises processing, using a control unit of the network entity, configuration information indicating a change in an availability of the resource; reacting on the change of the availability by performing by at least one of a measurement, a logging, a reporting, an acknowledging, and combinations thereof related to the availability; and providing a result thereof to the wireless communications system.

According to an embodiment a method for operating a network entity configured for a communication in a wireless communication system comprises generating configuration information indicating a change of an availability of a resource of the wireless communication system for a different network entity of the wireless communication system using a control unit of the network entity; and providing the configuration information to the wireless communication system and/or the different network entity.

According to an embodiment a computer readable digital storage medium is provided, having stored thereon a computer program having a program code for performing, when running on a computer, a method described herein.

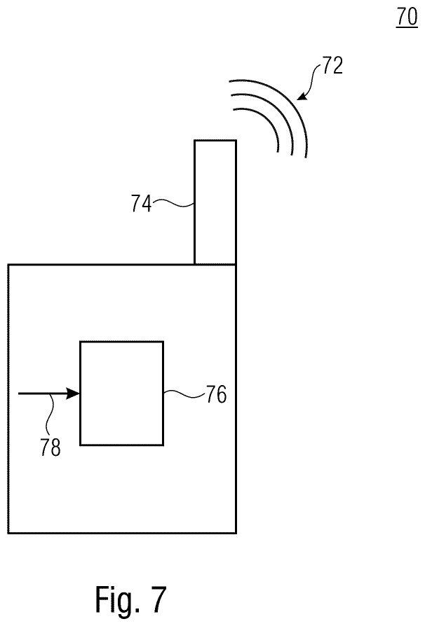

FIG. 7 shows a schematic block diagram of a network entity 70 according to an embodiment. Network entity 70 may operate, for example, as a UE, a base station, an IoT device, e.g., as described as a communication partner of the device and/or in connection with wireless network 100 or 200, but, alternatively or in addition, may operate as a different device or entity of a wireless communication system, e.g., a satellite, an airplane, or the like.

The network entity 70 is configured for a communication in a wireless communication system, e.g., by transmitting and/or receiving a wireless signal 72. The network entity 70 may comprise a wireless interface 74, e.g., having one or more antenna elements that are grouped into one or more antenna panels or antenna arrays. Optionally but not necessarily, the network entity 70 may be configured for implementing a beam forming technique, e.g., transmitting wireless signal 72 into a first direction with a higher transmission power when compared to a different direction and/or receiving a wireless signal from a first direction with a higher sensitivity when compared to a different direction.

According to an implementation that may be realized in addition to the features described for network entity 70 or that may provide for an alternative implementation of the network entity 70, the network entity 70 is configured for operating in a wireless communication system and comprises the control unit 76 configured for processing the configuration information 78 indicating a change in an availability of the resource used for communication. The control unit 76 is configured for reacting on the change of the availability by performing by at least one of a measurement, a logging, a reporting, an acknowledging, and combinations thereof related to the availability; and for providing a result thereof to the wireless communications system. That is, the change may lead to a reaction comprising a measurement, logging, reporting and/or acknowledging.

The communication in the wireless communication system may be organized according to a configuration that instructs a use of a resource of the wireless communication system. A configuration may include or relate to at least one of a transmission, a reception, or combinations thereof provided by the network entity as the communication. Alternatively or in addition, the configuration may relate to a measurement, a logging, a reporting, an acknowledging and/or combinations thereof to be provided by the network entity. Alternatively or in addition, the configuration may relate to a transmission and/or a reception of at least one preconfigured signal, e.g., a test signal, of at least one preconfigured reference signal and/or of at least one preconfigured message such as a test message. Alternatively or in addition, the configuration may relate to a performing of a procedure of transmission of at least one signal and/or a procedure of reception of at least one signal and processing thereof, e.g., beam sweeping, performing a frequency sweep or the like. For example, the configuration may indicate, describe or instruct a behavior of the network entity on how to perform its communication. For communication, a resource of the wireless communication system that is used may relate to a time resource, a frequency resource, a code resource but is not limited hereto. For example, a resource may not only relate to a resource element in the time-frequency grid but may also relate to a coverage, a service to be used or provided and/or other usable parts of a wireless communication system, amongst them:
an access link resource, a sidelink resource, a relay link resource and/or a backhaul link resource;
a temporal, spectral, sequential (spreading sequence) and/or spatial communication resource;
a transport channel, a positioning channel, a control channel and/or a data channel;
a transmission/reception beam represented by a beam-ID, SSB, CSI-RS, a beam sweep and/or a coordinated beam constellation;
a propagation channel component such as a line-of-sight, LOS, non-line-of-sight, NLOS, obstructed line-of-sight, OLOS, a dominant or specific multi-path component, (MPC;
a service or connectivity provided by another network entity such as a gNB, a core network, an access network, a repeater, a reconfigurable intelligent surface, RIS, or a satellite;
a quality of service, Qos, related to communication metrics such as coverage, capacity, latency and/or jitter

The network entity 70 comprises a control unit 76, e.g., an adapted implementation of a processor 202 or a different processing unit. The control unit 76 is configured for processing configuration information 78 that indicates a change of an availability of the resource. The control unit 76 is configured for adapting the configuration based on the configuration information to react on the change of the availability. The change may presently occur or may be an event to occur in future. However, this does not preclude to changing an event in the past.

By processing the configuration information, a possibly unexpected change in the availability of the resource becomes known and/or expected for the network entity 70 such that it can adapt its behavior, i.e., configuration. Embodiments of the present invention go beyond a rejection or acknowledgement of a grant of resources or a schedule of further communication. Such an adaptation of a grant of resources is considered to be a straightforward solution that is not unexpected for a network entity as it has knowledge about how to behave in a positive or negative response to a request. Embodiments provide for a solution, for example, on how to react in case of an availability or unavailability, e.g., a sudden unavailability of a link or other resources.

For example, the network entity 70 being implemented as a user equipment may be configured for adapting the configuration to change its behavior in the wireless communication system based on the change of the availability of the resource. For example, if communication is directed to or relayed via a network entity that is only discontinuously available, e.g., as being during sometimes out-of-sight and during other times in-range or providing a line-of-sight path, by use of the configuration information, the network entity 70 may become aware of those circumstances and may, for example, accumulate information to be transmitted to such entity until it again becomes available to thereby avoid, at least in parts, unnecessary transmissions. On the other hand, requests for re-transmissions or the like may be avoided as network entity 70 may be aware of the fact that although reception is expected, the other entity was unable to transmit and that a request for retransmission is possibly of low benefit or even useless.

Embodiments of the present invention in particular relate to an anomalous availability of the resource and/or a significant change of the availability. According to embodiments, the configuration information may lead the anomalous change of the availability to be an expected situation for the network entity. For example, the anomalous availability may relate to at least of:
a time, e.g., being or indicating a start, an end, a period, an interval, a duration and/or a change of state or change of trend and/or related to at least one of:
   an availability and/or non-availability of the resource;
   an occurrence of a blockage event blocking at least a part of the communication;
   an occurrence of an outage event and/or an outage period of the communication;
   an occurrence of an interference event and/or a jamming event influencing the communication;
   an occurrence of an energy related state and/or a power related state of the communication; Examples include a low battery state, a recharging time, an estimated remaining energy, one or more transmit power constraints due to EIRP restrictions, multi-band operation and/or interference constraints;
a Resources are subject to
   a decrease below a threshold of at least one parameter relevant for the communication,
   an increase above a threshold of at least one parameter relevant for the communication,
   a maintain within or outside a corridor of values of at least one parameter relevant for the communication,
   maintain within or outside a region or area of validity of at least one parameter relevant for the communication with respect to a metric; examples may include a coverage, a capacity, a data rate, a reliability and/or a latency
   a particular distribution of a parameter and/or states across a dimensions, e.g., a physical unit, of at least one parameter relevant for the communication using the resource; examples may include a time, a frequency, a space, a direction, a location, etc.
a constraint related to the resource in view of at least one of:
   a provided data volume;
   an allocated spectrum and/or resource block (RB);
   a modulation and coding scheme (MCS) used for the communication;
   a block size used for the communication
   a size of a message, a volume such as data volume or size of a folder/file or payload data and/or a number of messages, e.g., per unit time and/or unit of opportunity
   a change of any above, e.g., a state a value and/or a trend of change such as increase→decrease, decrease→increase and/or a rate of change
   a particular or repeated pattern, a distribution, a statistic, a state, a value and/or a trend of occurrence

One specific but nevertheless non-limiting example of the present invention, is a network entity such as a UE located, e.g., in a canyon and communicating with a moving satellite such that a Los-connection to the satellite is possibly interrupted by the canyon structure leading to an anomalous degradation of the link. With the knowledge, provided through the use of configuration information, of when the connection will be interrupted and/or possibly be interrupted in future, the network entity and/or the satellite may be aware of times during which the other entity is in range and may accordingly adapt their communication, amongst them: not transmitting a signal when the other entity is not reachable, avoiding re-transmissions or requests for that entity during that times and/or preparing communication for times during which communication is possible, e.g., reserving resources, collecting data to be transmitted and the like.

The configuration information may be stored or available in the network entity 70 and/or may be received by use of external signaling, e.g., using a wireless signal, e.g., from a network coordinator or cell coordinator such as a base station, from another peer, e.g., using a sidelink or by use of different interfaces including wired, optical and/or wireless interfaces.

Known or state-of-the-art (SOTA) wireless communication systems are designed such that they explore the availability of communication partners, e.g., availability of a cellular network or a Wi-Fi access point, then to measure or test a propagations environment using training sequences e.g. reference symbols transmitted by at least one of the communication partners, followed by a communication access procedure, configuration/negotiation of the link and network parameters and finally use a standardized communication procedure to transfer/exchange control and user data over the wireless link.

Due to the fact that the propagation channel might change in quality or availability to support a targeted or requested quality or reliability of wireless communication, methods of link adaptation and signalling of requested or available link parameters (data rate, latency) have been introduced in many wireless systems. Such wireless systems generally rely on currently known properties of the communication channel and the assumption that within link adaptation loop control delay such properties remain. Following this rational slowly varying changes of the channel conditions can be followed and the transmission scheme adapted accordingly.

In case of fluctuations in channel properties e.g., fast fading, sporadic or localized crosslink interference a variety of mitigation and compensation schemes have be introduced, among these are diversity schemes like spreading in time or frequency, antenna diversity and packet retransmission, packet duplication or channel codes are SOTA techniques to handle statistical fluctuations in channel properties. That is, in case of an such anomalous event occurring, there is not performed an adaption of a configuration but the communication scheme is designed to tolerate such events at least to some extent.

Still, the common base of all of these known schemes is that a certain kind of minimum level of communication can be maintained.

When such a minimum level of communication is lost, the wireless communication protocol starts timers and either waits and probes if the link quality recovers or continues a predefined mode of operation to reach the other communication by e.g., k-repetitions or starting a scan for other available communication resources with the communication partner e.g., in case of a link failure on a particular transmit-receive beam pair. In the case of prearranged alternative link options, an automatic link-failure recovery procedure can be activated which allows a faster link recovery due to a priori knowledge of alternative link options and a configuration to start a link failure recovery (LFR) procedure when certain conditions are met.

In case none of the above is successful, a device operated in known systems usually concludes the non-availability of coverage or service and starts triggers to re-enter the network discovery mode. Such behaviour can be observed with any cellular phone when operated in poorly covered areas e.g. mountainous terrain. In this example, when the device has completed yet another network scan process through which the device identifies the availability of a network, a random-access procedure can be initiated. Depending on the time duration between the loss of connection and the (re-) establishment of the other link or the determination of communication related parameters e.g., session ID, end-to-end encryption might have exceeded a predefined period of non-activity and a communication session must therefore be (re-) started from the beginning.

When compared to such known systems, the solution provided by the disclosed embodiments may provide means to handle communication interruptions and reduce the time needed for the (re-) establishment of communication(s), session(s) etc. significantly. This may be achieved through the use of configuration information relating to past, current and/or future occurrences of communication resource shortage/changes, so far not successfully covered by the above explained SOTA mechanisms. This also includes solutions to collect respective information allowing to generate such configuration information.

In order to address the problem described in connection with known systems, embodiments provide a technical solution to address the drawbacks, in particular in connection with a loss of communication but not limited hereto.

For example, when considering a wireless communication system, WCS, comprised of at least one but advantageously at least two UEs and with reference to the scenario described in connection with known systems, three scenarios may be identified:

| Scenario | Tag line | Description |
|---|---|---|
| A | Both UEs (still) in | the UEs are both (still) “in coverage” and “in service” of the |
| | | RAN. |
| B | Remote UE out | a first UE is “in coverage” but “out of service” and a second UE |
| | | is both “in coverage” and “in service” |
| C | Both UEs out | Both a first and a second UE are “out of coverage” and “out of |
| | | service”. |

With reference to Scenarios A, B and C, Scenario A depicts a WCS use case in which the at least two UEs are both IC and IS of the RAN. This could be considered to be an ideal situation or a reference situation since during this mode of operation, configuration information pertaining to communication resources is readily available not only for the present conditions but perhaps also for anticipated, expected or planned future conditions.

In contrast Scenario B depicts a WCS use case in which only one UE is IS even though both are IC. In a known state-of-the-art WCS, the out-of-service, OOS, UE is unaware of when, where and how communication resources will become or are expected to become available in the future. The OOS UE might therefore use its own resources in an unnecessary and/or ineffective manner. This could have the effect of at least reducing its battery capacity or creating interference to other users.

In Scenario C, in which both UEs are both OOC and OOS, the negative consequences of Scenario are exasperated even further which could result in even greater levels of interference and a degradation of service quality for other users.

The technical solution provided by embodiments attempts to alleviate the deleterious effects described in Scenarios B and C referred to as anomalous changes of an availability of a resource by ensuring that the UEs are provided with configuration information using one or more of the following methods or sources of information:
Pre-set or preconfigured (e.g. by default, factory settings, recently updated), e.g., stored in an internal or external memory
Based on a former, e.g., the last used mode of operation or the mode of operation or a change in the mode of operation (e.g. from Uu to sidelink, from sidelink to Uu, from Uu to NTN, from NTN to Uu, from SL to NTN or from NTN to SL)
Provided by the network/WCS, e.g., via a wireless or wired signal or message
Provided by a database (e.g. connected to the RAN as an entity), the information provided directly or indirectly (via a different entity) via a wireless or wired signal or message
Provided via an alternative RAN (e.g. Wi-Fi, Bluetooth)
Provided by a remote UE or a group leader UE or a different network entity

For example, the configuration information may be provided in the form of an Assisting Information Message AIM, wherein the one or more AIMs may include one or more of the following:
resource allocation related assistance information, like
   resource patters
   resource pools
   available and/or excluded radio resources
   information about particular frame structures, e.g., (pseudo)-TDD slot structures on FDD bands, sub-band full duplex, SBFD, configurations, almost blank subframes, ABS, in one or more FDD or TDD bands to be used for SL-communication
   a sub-band full duplex, SBFB, configuration indication
link related assistance information, like
   temporal (current and future), availability/unavailability, readiness of connectivity opportunities (e.g. windows of opportunity to see a satellite or satellite constellation areas), shortage or plentifulness of resources
timing advance assistance information
Doppler assistance information
distance related assistance information,
geographical area related assistance information,
group related assistance information,
UE pair related assistance information,
relay/repeater related assistance information,
capability information of a device transmitting or receiving the AIM,
requested information by the device transmitting or receiving the AIM about capability information to be provided by the UE,
a distress message header with wakeup, configuration state activation trigger function or priority purpose (e.g. transmitting an emergency message containing distress ID, requested action, location, UE-ID etc.).

The described three scenarios A, B and C above can be considered as example connectivity states of two UEs within the same coverage area and connected to the same RAN network e.g. via a satellite access link or a concatenated satellite backhaul link (scenario A).

While devices or entities (e.g. UEs) may be connected to the network via a gNB, their configuration and therefore their behaviour can be configured and controlled within the configuration framework.

Configuration in this context can be understood on different levels. For example, on a first level wherein the device is configured to support a particular feature to respond to signals/messages it will receive later; and on a second level wherein the device is configured in particular states which are valid within a framework of a feature. Examples for such configurations are not limited to include:
1^{st} level configuration: for example, a configuration of a device into a mode supported by a gNB/network. This may be done via RRC messaging and is therefore usually of larger message size and is relatively slow.
2^{nd} level configuration: for example, a configuration of relationships between reference symbols (RS), channels etc. via the transmission control information (TCI) which is using a highly compressed self-referencing messaging space.

According to embodiments a single level of configuration, two levels of configurations or even a higher number of levels may be used to cause the network entity to adapt its configuration, e.g., at least three, at least four, at least five, at least ten or even more. Different levels of the plurality of configuration information may comprise a different granularity or accuracy with regard to one or more parameters or a sequence of them. As an alternative or in addition, different levels of the plurality of configuration information may comprise different levels of priority, i.e., a configuration information of higher priority may lead to an adjustment or to discard or drop configuration information, at least for a same parameter, action or behaviour, available at a lower priority. However, as a further alternative or even in addition, an different levels of configuration information may be obtained, received or processed from different sources. Different sources may be understood, for example, as being received or retrieved from a same entity at different instances of times, e.g., by receiving different signals. This does not preclude to obtain, e.g., a first level of configuration information without receiving a signal, e.g., from an internal memory and a second level of configuration information, e.g., of higher priority, from a different source, e.g., by receiving a wireless signal. As long as the second level of configuration is unavailable, the network entity might still rely on the possibly pre-configured first level of configuration information.

For example, when a device/UE loses connectivity to the gNB/CU/access network or other network elements (e.g. other devices or the core network) connectivity to other devices can be maintained such that the further connectivity can be used to obtain configuration information from or via the device belonging to the remaining connection.

In the context of some embodiments related to this invention, the configuration information (CI) may consist of or may comprise information about and/or is associated with transmission/reception configurations relating to a particular kind of shortage of communication resources, in particular an anomalous shortage the CI can be communicated/provided via any available/remaining communication link.

The CI may refer to scarce/reduced or abundant/plentiful/sufficient resources and their past, current and future availability/non-availability.

Configuration may refer to one or more of:
Transmission, reception, and combinations thereof, e.g., provided by the network entity as part of the communication
Measuring/logging/reporting/acknowledging, and combinations thereof provided by the network entity
Transmission, reception of preconfigured (test or reference) signals/messages
Performing a procedure of transmission, reception of signals and processing thereof e.g., beam sweeping, frequency sweep,

Resources referred to in connection with embodiments may comprise one or more of:
Access link, sidelink or backhaul link resources
Temporal, spectral, spatial communication resources
Transport, positioning, control or data channels
Transmission beams (beam-IDs, beam sweeps, coordinated beam constellations)
Propagation channel components e.g., line-of-sight (LOS), non-line-of-sight (NLOS), obstructed line-of-sight (OLOS), dominant or specific multi-path components (MPC)
Service/connectivity provided by gNB, core network, access network, repeater, RIS, satellite
Quality of service (QOS) related to metrics like coverage, capacity, latency, jitter

An indication of availability of such a resource may refer to at least one of:
Time being a start, end, period/interval/duration or change of:
   Availability or non-availability of resources
   Occurrence of blockage event
   Occurrence of outage events or periods
   Occurrence of interference or jamming events
   Occurrence of energy or power related states e.g., low battery state, recharging time, estimated remaining energy, transmit power constraints due to EIRP restrictions, multi-band operation, interference constraints
   Resources may be subject to
      decrease of a parameter below a threshold,
      increase of a parameter above a threshold,
      maintain a parameter within or outside a corridor of values
      maintain a parameter within or outside a region or area of validity with respect to a metric e.g., coverage, capacity, data rate, reliability, latency
      a particular distribution across the dimensions of resources in e.g., time, frequency, space, directions, location, etc.
   Resources may be constrained by:
      Data volume
      Allocated spectrum, resource blocks (RB)
      Modulation and coding scheme (MCS)
      Block size
      Message size/message volume/number of messages (per unit time or unit of opportunity)
   the change of the availability may relate, e.g., to a change of any above states/values or trends (increase→decrease, decrease→increase)
   the availability may relate, e.g., to a particular or repeated patterns of occurrence, distribution, statistic, states, values or trends

Said examples of the availability advantageously match the respective resource. That is, for example, an availability of an access link may more relate to an availability or blockage event whilst a resource QoS may more relate to a block size or MCS when compared to the allocated spectrum, not precluding such an association.

As an alternative or in addition, the configuration information may further contain at least one of:
a trigger
an event
a condition
a combination or sequence of any of the above (including combinations of several triggers, events, conditions), e.g., indicating one or more of a:
   state,
   status,
   period,
   event,
   request,
   report,
   action,
   procedure, to:
start/pause/continue/end
activate/deactivate
confirm/acknowledge.

Among actions/procedures requested or activated by e.g. a trigger or event are:
starting/stopping/resetting/halting of counters or count-down timers
capturing, freezing, storing, forwarding current and future (anticipated) states and configurations
automatic (re)-configuration after a trigger/event occurred, or condition is met
starting/halting/delaying/restarting/preparing to start a procedure or mode of operation,
changing from one procedure, routine or mode of operation into another one
determining or selecting a mode of operation, a transmission/reception strategy
discovering/observing/detecting/monitoring/tracing events or parameters related to any of the above CI and associated actions, triggers, configuration variants thereof (example: UE is observing pattern of availability of one or more beams based on RS or beam-ID and determining or reporting future availability, based on this another device e.g., a gNB or RIS can be configured to go/remain in particular configuration states such that a certain coverage/capacity requirement of a particular UE is fulfilled)
prepare reports/messages/control or user data transmissions/receptions to be ready to be transmitted/received at one of the next/future connection availability events.

Embodiments described above relate to a network entity that adapts its configuration based on configuration information. Embodiments also relate to obtaining, collecting and/or providing such configuration information.

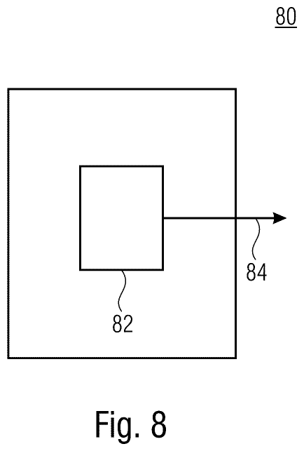

FIG. 8 shows a schematic block diagram of a network entity 80 according to an embodiment. The network entity 80, e.g., being also in accordance with the features described in connection with network entity 70 or being a different network entity, is configured for a communication in a wireless communication system. The network entity 80 comprises a control unit 82 that is configured for generating configuration information 84 indicating a change of an availability of a resource of the wireless communication system for a different network entity of the wireless communication system. The configuration information 84 may comprise at least a part of the configuration information 78 and/or may comprise different configuration information described herein. The network entity 80 is configured for providing the configuration information 84 to the wireless communication system and/or the different network entity. It may, according to an embodiment, use the configuration information for an own purpose as described in connection with network entity 70.

However, when compared to the network entity 70, the network entity providing the configuration information is not necessarily required to communicate in the WCS by use of the RAN and/or the communication scheme. The network entity 80, may, for example, operate as a sensor or other measurement and/or logging device providing respective data or information, e.g., based on its configuration and/or upon request. The configuration information 84 may be provided to other devices by use of a wired, optical and/or wireless (radio) interface and a respective signal. For example, providing the configuration information 84 to a memory using a wired signal, the memory accessible to the network entity 70 via a RAN may allow to implement the network entity 80 without a wireless interface such as wireless interface 74.

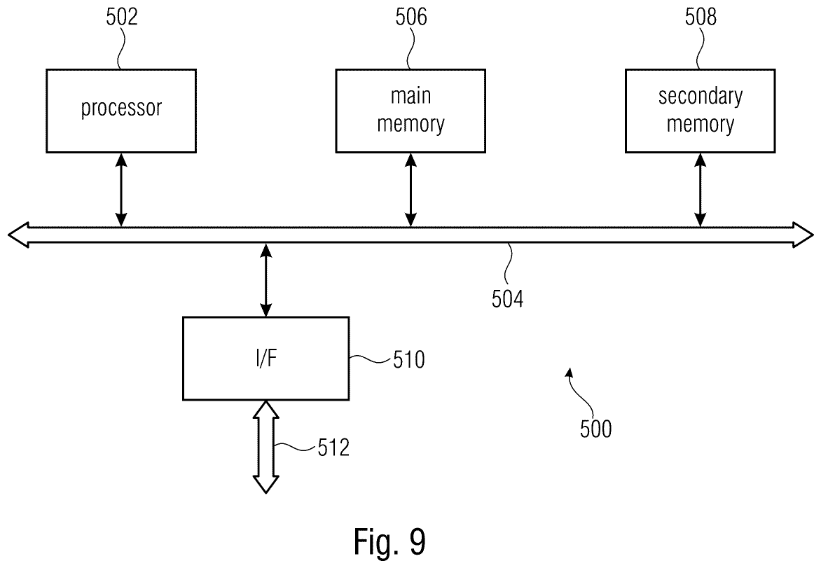

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 9 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

ABBREVIATIONS

| Abbreviation | Definition |
|---|---|
| 2G | second generation |
| 3G | third generation |
| 3GPP | third generation partnership project |
| 3PC | third-party controller |
| 4G | fourth generation |
| 5G | fifth generation |
| 5GC | 5G core network |
| AAS | active antenna system |
| AAU | advanced antenna unit |
| ACLR | adjacent channel leakage ratio |
| ADC | analogue-to-digital converter |
| AF | application function |
| AP | access point |
| ARQ | automatic repeat request |
| AU | antenna unit |
| BER | bit-error rate |
| BLER | block-error rate |
| BP | behaviour plane |
| BS | basestation transceiver |
| BT | Bluetooth |
| BTS | basestation transceiver |
| CA | carrier aggregation |
| CBR | channel busy ratio |
| CC | component carrier |
| CCO | coverage and capacity optimization |
| CHO | conditional handover |
| CLI | cross-link interference |
| CLI-RSS | cross-link interference received signal |
| CP | control plane |
| CP1 | control plane 1 |
| CP2 | control plane 2 |
| CPRI | common public radio interface |
| CSI-RS | channel state information reference signal |
| CU | central/centralized unit |
| D2D | device-to-device |
| DAPS | dual active protocol stack |
| DAC | digital-to-analogue converter |
| DC-CA | dual-connectivity carrier aggregation |
| DECT | digitally enhanced cordless telephony |
| DL | downlink |
| Abbreviation | Definition |
| DMRS | demodulation reference signal |
| DOA | direction of arrival |
| DRB | data radio bearer |
| DT | digital twin |
| DU | distributed unit |
| ECGI | e-UTRAN cell global identifier |
| E-CID | enhanced cell ID |
| eCPRI | enhanced CPRI |
| eNB | evolved Node b |
| EN-DC | e-UTRAN-New Radio dual connectivity |
| EUTRA | enhanced UTRA |
| E-UTRAN | enhanced UTRA network |
| FSS | frequency-selective surface |
| gNB | next generation NodeB |
| GNSS | global navigation satellite system |
| GPS | global positioning system |
| GSO | geostationary orbit |
| HAPS | high-altitude platforms |
| HARQ | hybrid ARQ |
| IAB | integrated access and backhaul |
| IC | in-coverage |
| ID | identity / identification |
| IF | intermediate frequency |
| IS | in-service |
| IIOT | industrial internet of things |
| KPI | key-performance indicator |
| LTE | long-term evolution |
| MCG | master cell group |
| MCS | modulation coding scheme |
| MDT | minimization of drive tests |
| MIMO | multiple-input / multiple-output |
| MLR | measure, log and report |
| MLRD | MLR device |
| MNO | mobile network operator |
| MR-DC | multi-rat dual connectivity |
| NCGI | new radio cell global identifier |
| NEF | network exposure function |
| NG | next generation |
| ng-eNB | next generation eNB |
| NG-RAN | either a gNB or an NG-eNB |
| NGSO | non-geostationary orbit |
| NIC | network interface connection |
| NR | new radio |
| NR-U | NR unlicensed |
| NTN | non-terrestrial network |
| OAM | operation and maintenance |
| OEM | original equipment manufacturer |
| OOC | out-of-coverage |
| OOS | out-of-service |
| OTT | over-the-top |
| ORAN | see open RAN |
| Open RAN | open radio access network |
| PCI | physical cell identifier |
| PDCP | packet data convergence protocol |
| PER | packet error rate |
| PHY | physical |
| PLMN | public land mobile network |
| QCL | quasi colocation |
| RA | random access |
| RACH | random access channel |
| RAN | radio access network |
| RAT | radio access technology |
| RF | radio frequency |
| RIM | radio access network information |
| RIM-RS | rim reference signal |
| RIS | reconfigurable intelligent surface |
| RISC | RIS controller |
| RLC | radio link control |
| RLF | radio link failure |
| RLM | radio link monitoring |
| RP | reception point |
| R-PLMN | registered public land mobile network |
| RRC | radio resource control |
| RRU | remote radio unit |
| RS | reference signal |
| RSRP | reference signal received power |
| RSRQ | reference signal received quality |
| RSSI | received signal strength indicator |
| RSTD | reference signal time difference |
| RTOA | relative time of arrival |
| RTT | round trip time |
| RU | radio unit |
| SA | standalone |
| SCEF | service capability exposure function |
| SCG | secondary cell group |
| SDU | service data unit |
| SIB | system information block |
| SINR | signal-to-interference-plus-noise ratio |
| SIR | signal-to-interference ratio |
| SL | sidelink |
| SL-BC | sidelink broadcast |
| SNR | signal-to-noise ratio |
| SON | self-organising network |
| SOTA | state-of-the-art |
| SRS | sounding reference signal |
| SS | synchronization signal |
| SSB | synchronization signal block |
| SSID | service set identifier |
| SS-PBCH | sounding signal / physical broadcast |
| TAC | tracking area code |
| TB | transmission block |
| TDD | time division duplex |
| TN | terrestrial network |
| TSG | technical specification group |
| UAV | unmanned airborne vehicle |
| UE | user equipment |
| UL | uplink |
| UP | user plane |
| URLLC | ultra-reliable low latency communication |
| UTRAN | universal trunked radio access network |
| Uu | UE can use NR radio access |
| V2X | vehicle-to-everything |
| VoIP | voice over internet protocol |
| VRAN | virtual ran |
| WI | work item |
| WLAN | wireless local area network |

1. A network entity configured for a communication in a wireless communication system according to a configuration using a resource of the wireless communication system and for using a wireless interface of the network entity for the communication, the network entity comprising:
a control unit configured for processing configuration information indicating a change of an availability of the resource;
wherein the control unit is configured for adapting the configuration based on the configuration information to react on the change of the availability.

2. The network entity of claim 1, wherein the network entity is a user equipment, UE, that is configured for adapting the configuration to change its behavior in the wireless communication system based on the change of the availability of the resource.

3. The network entity of claim 1, wherein the change relates to an anomalous availability of the resource and/or a significant change of the availability.

4. The network entity of claim 3, wherein the configuration information leads the anomalous change to be an expected situation for the network entity.

5. The network entity of claim 3, wherein the anomalous availability relates to at least one of:
a time related to at least one of:
an availability and/or non-availability of the resource;
an occurrence of a blockage event blocking at least a part of the communication;
an occurrence of an outage event and/or an outage period of the communication;
an occurrence of an interference event and/or a jamming event influencing the communication;
an occurrence of an energy related state and/or a power related state of the communication;
a resource is subject to
a decrease below a threshold of at least one parameter relevant for the communication,
an increase above a threshold of at least one parameter relevant for the communication,
a maintain within or outside a corridor of values of at least one parameter relevant for the communication,
maintain within or outside a region or area of validity of at least one parameter relevant for the communication with respect to a metric,
a particular distribution across a dimensions of at least one parameter relevant for the communication using the resource
a constraint related to the resource in view of at least one of:
a provided data volume;
an allocated spectrum and/or resource block (RB);
a modulation and coding scheme (MCS) used for the communication;
a block size used for the communication
a size of a message, a volume and/or a number of messages, e.g., per unit time and/or unit of opportunity
a change of any above
a particular or repeated pattern, a distribution, a statistic, a state, a value and/or a trend of occurrence.

6. The network entity of claim 1, wherein the configuration information relates to an availability of the resource; or
wherein the configuration information relates to an at least partial unavailability of the resource.

7. The network entity of claim 1, wherein the configuration information indicates the change of the availability for a past, present and/or future instance of time.

8. The network entity of claim 1, wherein the control unit is configured for processing the configuration information to acquire a processing result that indicates an at least partial and/or at least temporal unavailability of the resource for the communication; and
wherein the control unit is configured for controlling the network entity to avoid the communication using the resource based on the processing result.

9. The network entity of claim 1, wherein the control unit is configured for processing the configuration information to acquire a processing result that indicates a restored availability of the resource for the communication and/or that indicates an established availability of the resource; and
wherein the control unit is configured for controlling the network entity to postpone the communication using the resource based on the processing result until the availability of the resource for the communication is restored or established.

10. The network entity of claim 1, wherein the configuration relates to at least one of:
a transmission, a reception, and combinations thereof provided by the network entity as the communication;
a measurement, a logging, a reporting an acknowledging, and combinations thereof to be provided by the network entity;
a transmission and/or a reception of at least one preconfigured signal such as a test signal, of at least one preconfigured reference signal, and/or of at least one preconfigured message such as a test message;
a performing of a procedure of transmission of at least one signal and/or a procedure of reception of at least one signal and processing thereof, e.g., beam sweeping, frequency sweep.

11. The network entity of claim 1, wherein the resource comprises at least one of:
an access link resource, a sidelink resource, a relay link resource and/or a backhaul link resource;
a temporal, spectral, sequential (spreading sequence) and/or spatial communication resource;
a transport channel, a positioning channel, a control channel and/or a data channel;
a transmission/reception beam represented by a beam-ID, SSB, CSI-RS, a beam sweep and/or a coordinated beam constellation;
a propagation channel component such as a line-of-sight, LOS, non-line-of-sight, NLOS, obstructed line-of-sight, OLOS, a dominant or specific multi-path component, (MPC;
a service or connectivity provided by another network entity;
a quality of service, Qos, related to communication metrics such as coverage, capacity, latency and/or jitter.

12. The network entity of claim 1, wherein the configuration information comprises at least one of:
information indicating at least one trigger indicating to start or stop a particular action/behaviour of the device;
information indicating at least one event which is relevant to the communication scenario;
information indicating at least one condition which describes e.g., the communication scenario, status values/messages of the UE or other network devices;
information indicating a combination or sequence thereof indicating at least one of:
a state, e.g., of a state machine,
a status, e.g., of a report, action, confirmation or acknowledgment,
a period, of a parameter being below/above a threshold or within a range OR a certain state/status is given/valid/invalid,
an event,
a request of an action, observation and/or measurement,
a report relating to an action, observation and/or measurement,
an action, e.g., of stopping a counter, continuing until something else happens,
a procedure, to:
start/pause/continue/end;
activate/deactivate; and/or
confirm/acknowledge, e.g., of actions, reports, status.

13. The network entity of claim 1, wherein the configuration information comprises information indicating an event or trigger; wherein based on the processing, the control unit is configured for controlling the network entity responsive to the event or trigger to at least one of:
starting, stopping, resetting and/or halting of at least one counter and/or count-down timer;
capturing, freezing, storing, forwarding a current and/or future, e.g., anticipated state and/or configuration;
an automatic (re)-configuration of the network device and/or its behaviour after a trigger, after an event occurred and/or after a condition is met;
starting, halting, delaying, restarting and/or preparing to start a procedure or mode of operation of the network entity,
changing from one procedure, routine or mode of operation into another one;
determining or selecting a mode of operation and/or a transmission/reception strategy;
discovering, observing, detecting, monitoring and/or tracing an events and/or a parameter related to any of the above configuration information and/or associated actions, triggers, configuration variants thereof;
preparing a transmission and/or reception of at least one of a report, a message, control data and user data; for preparing of a future connection availability events.

14. The network entity of claim 1, wherein the network entity is configured for acquiring the configuration information based on at least one of:
as a pre-set or pre-configured information;
based on a past, present or future mode of operation or a change in the mode of operation;
as information provided by the wireless communication system;
as information provided by a database;
as information provided via an alternative radio access network, RAN,
as information provided by a remote UE and/or a group leader UE.

15. The network entity of claim 1, wherein the network entity is configured for acquiring the configuration information as one of a plurality of configuration information.

16. The network entity of claim 15, wherein the network entity is configured for receiving at least one of the plurality of configuration information by receiving and processing a wireless signal.

17. The network entity of claim 15, wherein the network entity is configured for acquiring a first configuration information that causes the control unit to control the network entity into an operation mode supported by a wireless communication system controller, e.g., via a radio resource control, RRC, message;
wherein the network entity is configured for acquiring a second configuration information that causes the control unit to control the network entity into one of different behaviors within the operation mode.

18. The network entity of claim 17, wherein the network entity is configured for receiving at least a part of the first configuration information by receiving a radio resource control, RRC, message; wherein the network entity is configured for acquiring at least a part of the second configuration information by receiving a transmission control information, TCI.

19. The network entity of claim 1, being a user equipment, UE.

20. The network entity of claim 1, wherein the configuration information is a first configuration information; wherein the control unit is configured for generating the first configuration information and/or for generating a second configuration information indicating a change of an availability of a resource of the wireless communication system for a different network entity of the wireless communication system;
wherein the network entity is configured for providing the first configuration information and/or the second first configuration information to the wireless communication system and/or the different network entity.

21. A network entity configured for operating in a wireless communication system, the network entity comprising:
a control unit configured for processing configuration information indicating a change in an availability of the resource;
wherein the control unit is configured for reacting on the change of the availability by performing by at least one of a measurement, a logging, a reporting, an acknowledging, and combinations thereof related to the availability; and for providing a result thereof to the wireless communications system.

22. A network entity configured for a communication in a wireless communication system, the network entity comprising:
a control unit configured for generating configuration information indicating a change of an availability of a resource of the wireless communication system for a different network entity of the wireless communication system;
wherein the network entity is configured for providing the configuration information to the wireless communication system and/or the different network entity.

23. The network entity of claim 22, being a user equipment, UE configured for wirelessly providing the configuration information using a wireless interface of the network entity.

24. The network entity of claim 22, being a base station, gNB, configured for wirelessly providing the configuration information using a wireless interface of the network entity.

25. The network entity of claim 22, wherein the configuration information is a first configuration information and wherein the resource is a first resource; wherein the network entity is configured for a communication in the wireless communication system according to a configuration using a same or different second resource of the wireless communication system and for using a wireless interface of the network entity for the communication;
wherein the control unit is configured for processing second configuration information indicating a change of an availability of the second resource;
wherein the control unit is configured for adapting the configuration based on the second configuration information to react on the change of the availability.

26. A wireless communication system providing wireless communication between different entities of the wireless communication system according to a configuration, the communication using a resource of the wireless communication system, the wireless communication system comprising:
a first entity being configured for providing, to at least one member of the wireless communication system, configuration information indicating a change of an availability of a resource of the wireless communication system;
a second entity that is configured for adapting the configuration based on the configuration information to mitigate an effect of the change of the availability on at least one entity of the wireless communication system.

27. The wireless communication system of claim 26, wherein the first entity is a network entity according to claim 1 or 21; and/or wherein the second entity is a network entity according to claim 22.
